(19) United States
(12) Patent Application Publication
(10) Pub. No.: US 2002/0161802 A1
(43) Pub. Date: Oct. 31, 2002

(54) Web presentation management system

(76) Inventors: Kurt A. Gabrick, San Ramon, CA (US); David B. Weiss, San Ramon, CA (US)

Correspondence Address: HEDMAN & COSTIGAN, P.C., 1185 Avenue of the Americas, New York, NY, 10036, US

(21) Appl. No.: 09/793,928

(22) Filed: Feb. 27, 2001

(51) Int. Cl. G06F 17/21

(52) U.S. Cl. 707/517; 707/523

(57) ABSTRACT

A method for managing web server presentations comprised of the steps of analyzing attributes associated with a web request from a user; formatting a document to be sent to the user based upon the attributes; and transmitting data corresponding to a document to the user.

### FIELD OF THE INVENTION

The present invention relates to the field of computer software and more particularly Internet software relating web management systems.

### BACKGROUND OF THE INVENTION

The Internet is comprised of a vast network of computers acting as web servers that can be accessed through various devices such as traditional web browsers, wireless devices, cellular telephones, and personal digital assistants (“PDAs”).

Typically, Internet users obtain data from a web server through an HTTP request by typing in a URL. The term “data” as used herein can include any information, signal, file, code output or other type of communication. When the URL is entered, the data associated therewith is transmitted to the user in the form it is stored on the server. The user's device then formats and displays from the perspective of the manufacturer of the device.

In the method of the prior art, the concerns of the web site host are not considered, to the detriment of the host. Additionally, leaving the determinations of data presentation up the device does not maximize the potential of what data from the particular site is represented to the user.

It is therefore an object of the invention to provide the most appropriate interface possible to web users. For instance, when a request is made by a user in the United States who is using a cell phone connection providing Internet access, a document should be returned that is written in US English and that is formatted properly to be displayed on the user's cell phone.

It is a further object to provide such interface to the user seamlessly and rapidly.

### SUMMARY OF THE INVENTION

These and other objects are achieved by the present invention, directed to a method of managing web presentation comprising the steps of analyzing attributes associated with a web request from a user, formatting a document to be sent to the user based on the attributes and transmitting data corresponding to the document to the user.

Additional aspects preferably include formatting a set of commands based on the attributes and executing a command to form a document. In its preferred embodiment a translator is used for translating a page having a standard format. The preferred translator includes a stylesheet for transforming a document into a response page suited to the user.

The present invention further contemplates the preemptive caching of web instances to increase the speed in which the data can be presented to the particular user on the particular device being used.

### BRIEF DESCRIPTION OF THE DRAWINGS

The following drawings, in which like reference characters indicate like parts, are intended solely to illustrate a preferred embodiment of the present invention without limiting the invention in any manner whatsoever.

FIG. 1 is a diagram of the dynamic response building process.

FIG. 2 is a diagram of the preferred embodiment of the web request handling process.

### DESCRIPTION OF THE INVENTION

The invention is comprised of a method for building a response to a web request utilizing applications to format data for presentation to a user, as shown in the Figures.

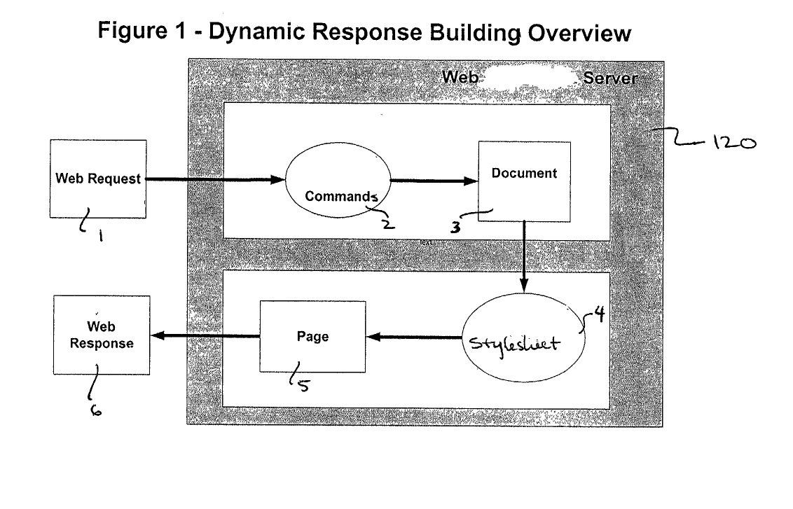

FIG. 1 shows the dynamic response building overview, which begins when a web user makes a web request 1, and culminates with the generation of a web response 6 by a web server 120. The web request 1 can be made using client software such as a web browser, by typing in a URL or by any other method known in the art. A web request 1 includes but is not limited to any request for an Internet resource such as that defined in the HTTP protocol specification from the World Wide Web consortium (W3C).

The web server 120 examines the contents of the web request 1 in addition to other parameters sent by the client software, such as the URL, to determine the set of commands 2 that must be performed in order to respond to the web request 1. The term “commands” is used herein to refer to a unique transaction executed by the web server 120 in response to a given web request 1 and a transaction is unique if the processing rules of the executing logic do not change based on data values, input or output from the process.

After determining the set of commands 2 the web server 120 communicates with external applications and data sources as necessary in order to obtain information to respond to the web request 1. The web server 120 may communicate with the external applications and data sources via built-in adapter framework, as more fully described below. A single adapter may connect to multiple systems in the course of serving a single web request 1 so that information residing in disparate data sources can be updated and retrieved via execution of a single set of commands 2.

Once the web server 120 has obtained any necessary information form external sources it executes the responsive set of commands 2 and stores the resulting data in document 3. The term “document” as used herein refers to a representation of the result of a command execution. A document 3 contains only data, without regard to how it should be formatted for transmission to the user.

After a document 3 is generated it is transformed along a stylesheet 4 within a translator into a response page 5. The term “page” as used herein refers to formatted output to be sent in a web response 6 to the user. The page 5 is a standardized representation of the document 3 selected according to the characteristics of the user's software and access devices.

Any commercially available translator can be used to transform source documents, however, the extensible stylesheet language translator (XSLT) is the preferred document translator currently contemplated for use herein. XSLT uses the extensible markup language (XML) based standard. An XLST engine is a third party software package that performs XSLT transformations. XML is extensible markup language which is a subset of ISO 8879 standard generalized markup language (SGML). The XML subset of SGML has been specifically designed to function on the web.

A web adapter is used to link the web server 120 to the translator. Preferably, the XSLT adapter is used to link the web server 120 to the XSLT engine.

To ensure that the optimal response to the web request 1 is created, the web server 120 of the present invention evaluates numerous attributes of the individual user's web request 1 and session data. The term “session” refers to contextual information stored about a user's interaction with the web server 120 across multiple web requests 1. This information is contained in the HTTP headers that are sent with the user's web request 1, as well as within the session context information that the web server 120 maintains about its interactions with the user.

The parameters for transforming a document 3 into a response page 5 are preferably provided by a stylesheet 4. The stylesheet 4 contains a stylesheet map which is a set of configuration data for the specific documents 3 within the web server 120 that most closely match the list of attributes of the user and the web request 1. The attributes that are used in the analysis may include the user's device type, session data, client software, location, country, dialect, and user group. Additional attributes may be used and the attributes listed are not intended to limit the scope of the present invention in any way.

The final step in the dynamic response method is the delivery of the page 5 in the form of a web response 6 to the user.

The time required for a web server 120 to respond to a web request 1 can be reduced using the dynamic response method of the present invention. Response time can be reduced since a single instance of a web server 120 can be used to provide many different views of a web application in a single, integrated presentation layer. The use of multiple executions resulting in multiple web server 120 instances is avoided since a document 3 can be created independent of the interface, and the interface is created at runtime in response to web request 1.

Further enhancements in the performance of the web server 120 can also be obtained by utilizing the dynamic response method with preemptive caching and multiple level preemptive caching. Preemptive caching greatly reduces the time when responding to an actual web request, because the majority of the computation required has already been done.

Preemptive caching involves the steps of simulating web requests 1 before users have actually made them in addition to storing web requests 1 previously sent to the web server 120. In a web server 120 using preemptive caching configuration data and common cache requests are read by the web server 120 automatically upon system startup or manually anytime thereafter. A “cache request” as used herein refers to a set of configuration data used by the web server 120 to process a simulated web response 6 in advance of a web request 1 being made by a user. Each cache request provides enough data to create and process a web request 1 without user intervention.

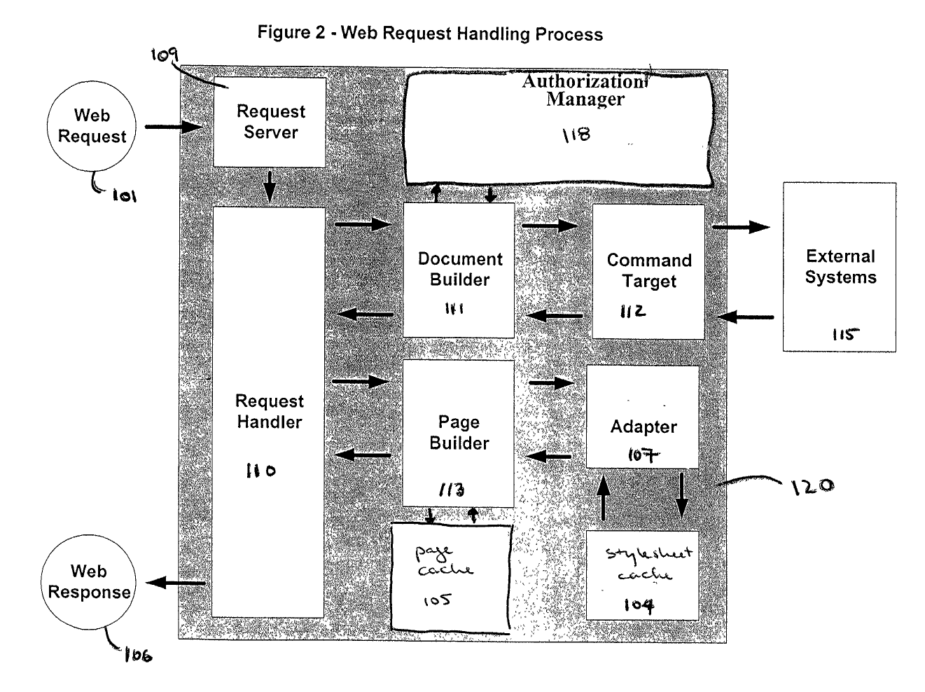

Referring to FIG. 2 each cache request is used to create a simulated web request 101, which is passed to the request handler 110 just as an actual web request 101 would be. The request handler 110 provides a central request-handling algorithm of the web server 120. This component accepts an individual web request 101 from a request server 109 to ensure that the proper command 2 is executed and the appropriate web response 106 is returned to the client. The document 3, page 5, and compiled stylesheet 4 used in responding to the cache request are then cached and ready to serve an actual web request 101.

The list of configuration parameters included in a cache request can include but is not limited to the following attributes:

URI—the HTTP request URI that should be sent to the server. The term “URI” as used herein refers to a uniform resource identifier, as defined by HTTP protocol. This is the URI of the web request, without the protocol and host portions included. The web server 120 services the simulated web request 101 in exactly the same manner as an ordinary request 101.

MAP-ID—the identifier of the stylesheet map that should be used when responding to the web request.

ENTRY-ID—the identifier of the map entry that should be chosen when the stylesheet map is evaluated.

The preemptive caching process reads the specified map entry and builds a web request 101 that matches the attributes of one or more web request. The web request 101 is then sent to the web server 120, with the request URI specified in the cache request.

Even greater enhancements in web server 120 performance can be obtained by utilizing the dynamic response method of the present invention with multiple level caching. While data caching is a technique used in many enterprise-class software products, web presentation management systems made according to the current invention combine multiple levels of caching to maximize web server 120 performance and minimize the time required for web response 106. Caching can be performed at the document level, at the stylesheet level and the page level, or in combinations thereof, in order to provide a dynamic response.

The present invention further contemplates the use of a unique network protocol called session replication protocol (“SRPL”) which provides the ability to replicate sessions among instances of itself SRPL allows local session data to be sent to one or more other servers, to provide backup of the information and allow user sessions to fail over to another server instance, in the event of a catastrophic failure of this instance. SRPL also allows copies of session data received from other server instances and the ownership transfer of a specific session between server instances.

SRPL is a TCP/IP socket-based protocol for replicating and transferring session objects between instances of the web server 120. A “source instance” opens a socket to a “target instance” and initiates a dialog to accomplish one of two tasks, to send a collection of session objects owned by the source instance to the target instance and/or to transfer ownership of a particular session from the target instance to the source instance. This occurs when the source instance finds itself servicing a web request 1 from a user whose session is the property of another server instance. If the owning server instance is still running, it is notified that the source instance is taking control of the user's session data.

When a source instance wishes to backup its session data to a target instance, the source instance opens a TCP socket connection to the target instance. The source instance then sends the following data to the target:

a. The literal string “REPLICATE”;

b. The literal string “Peer::” plus the IP number of the source instance;

c. The literal string “Port::” plus the port number being used by the source instance;

d. A serialized Java object representing all of the active Sessions currently managed by the source instance.

Upon validating the format and sequence of the data sent by the source instance, the target instance deserializes the Java object sent in step d and adds any session objects found therein to its list of known sessions that are being managed by other web server instances.

When the source instance encounters a valid session that is not under its own management, it takes control of that session by informing the session's previous owner (the target instance, in this case) that it will now manage the session. The source instance opens a TCP socket connection to the target instance. The source instance then sends the following data to the target:

a. The literal string “TRANSFER”;

b. The literal string “Session::” plus the unique identifier of the Session to be transferred.

The target instance, upon validating the format and sequence of the data sent by the source instance, locates its local copy of the specified session and marks it as being under the management of the source instance.

### EXAMPLE

A preferred embodiment of a web request handling process is described below in an example of the invention shown in FIG. 2.

### Step 1: Accept a Web Request

One or more request servers 109 listen for web requests 101 at a specific network address and port. As each web request 101 arrives at a request server 109, a new request handler object is created. The unmodified web request 101 is passed to the request handler 110, and the request server 109 continues to listen for additional web requests 101.

### Step 2: Prepare to Execute a Command

2.1: Retrieve or Create a User Session.

A user session is retrieved or created whereby the request handler 110 inspects the web request 101 for an HTTP cookie that uniquely identifies the user's session object in the web server 120. If a cookie is found it is used to locate the user's session object. If the cookie is not found, or if no session matching the identifier in the cookie is found, a new session is created and assigned to the user.

2.2: Pass Web Request and Session to Document Builder 103

The request handler 110 then passes the unmodified web request 101 and the session to the document builder 111. The term “document builder” refers to a subsystem of the web server 120 that is responsible for executing commands 2 and returning documents 3 for use in page builder's XSLT transformation process. This subsystem includes the document builder component and all command targets 112 within the system.

### Step 3: Invoke a Command Target

3.1: Locate the Appropriate Command Target.

The document builder 111 inspects the web request 101 to determine which command target 112 should be invoked. To do this, the document builder 111 first searches for a parameter (either passed as an HTTP POST parameter or appended to the query string of the web request's 1 URL) named “command”. If such a parameter is found, its value is compared to all known command names from the web server's configuration.

If the parameter is not found, document builder 111 examines the URI portion of the URL of the web request 101 to determine if the first portion of the URI contains a command name. The text found between the initial ‘/’ character of the URI and the next ‘/’ (or the end of the URI if no second ‘/’ is found) is compared to all known command names.

If no command name has been found using either technique above, document builder 111 sets the target command name to the default command name found in the web server's configuration.

Once a valid command name has been determined for this web request 101, the command specification referred to by this name is inspected to determine the fully qualified Java class name of the command target 112 that services the command target.

3.2: Verify User Privilege to Execute this Command, if Necessary

Document builder 111 inspects the command specification to determine if an authorization check is required before this command may be executed. If so, document builder 111 invokes the authorization manager 118 subsystem to determine if the current user is authorized to execute this command 2. If this check fails, document builder 111 aborts processing, and an HTTP challenge reply is returned to the user. The user may choose to provide credentials that authorize him/her to execute this command 2 in a subsequent request.

3.3: Load and Execute the Command Target

If not already loaded, document builder 111 loads this command target 112 and invokes its execute method, passing to it the original web request 101, the session, and the command specification.

### Step 4: Begin Command Execution

The command target 112 inspects the command specification, session and web request 101 to determine the steps that must be taken to build the document 3 that will serve as the base data for the eventual web response 106 sent back to the user. The term “command specification” refers to a server transaction executed by the web server 120 in response to a given command 2 to a command target 112, and provides additional information to the command target 112 regarding how the command 2 should be carried out. The term “command target” refers to a software adapter employed by the document builder 111 to execute a given command 2. The command target 112 is responsible for sending data to external systems 115 and ensuring that any data returned from external systems is represented as well formed XML before returning it to document builder 111.

4.1: Check Document Cache

The command target 112 first checks the document cache to determine if this command has been previously executed and produced a document 3 that can be used to service this web request 101. If such a non-expired document 3 is found in the document cache, it is returned to document builder 111 and processing ends.

4.2: Prepare to Execute

The details of this activity are specific to each command target 112.

### Step 5: Interact with External Systems

The command target 112 may now interact with external systems 115 and resources. There are no limits imposed by the web server 120 as to what this interaction may be. Commonly this interaction will consist of sending data to another system, making remote method/procedure calls, and requesting external resources.

### Step 6: End Command Execution

6.1: Build an XML Data Representation

The command target 112 now builds an XML document 3 in-memory which represents the residual data obtained from execution of the command 2. In some cases, the interaction in Step 5 may have created an XML representation directly, but in others, the command target 112 will transform other data formats into XML.

6.2: Create a Document

The command target 112 also adds two required XML processing instructions (PI) to the XML data tree. One is a “document-id” PI, which denotes the unique identifier for this document 103 in the server. The other is a “cache-date” PI, which denotes the time at which this document 3 must be removed from the document cache, should document builder 111 choose to cache the document. Once these PIs have been added to the XML data, a document 3 has been created.

### Step 7: Validate and Cache Document

7.1: Cache and Return a Valid Document

Document builder 111 receives the document back from the command target 112 and validates that it is not null and contains the required PIs. If so, the document 3 is added to the document cache and a copy of the document is returned to the request handler 110.

7.2: Abort Processing if a Document Cannot be Built

If the document 3 is null or invalid, document builder 111 invokes the get reply method of the command target 112 to determine the error that occurred, and reports this information back to the request handler 110. At this point, processing is aborted and the web server's 120 error handling process is invoked.

### Step 8: Invoke Document Transformation Process

Request handler 110 passes the document 3 returned from document builder 111 to page builder 113, along with the original web request 101 and the session.

### Step 9: Prepare to Transform Document

9.1: Determine if User has Requested this URI Previously.

Page builder 113 first checks the session to determine if the requested URI has already been serviced for this user. If so, the page cache is checked to determine if there is a suitable response page 5 already cached. If such a page 5 is found, it is returned to request handler 110 and processing terminates.

9.2: Determine User-Agent and MIME Type

Page builder 113 inspects the web request 101 user-agent HTTP header and attempts to determine the preferred MIME type for the web response 106 from it. The web server 120 maintains a map of user-agent names to MIME types in its configuration. If the web request 101 originates from a known user-agent, the MIME type for the web response 106 is set to the corresponding MIME type found in the server's map.

If the user-agent header is not found, or if an unknown user-agent is found, page builder 113 inspects the URI of the web request 101 to try to determine the appropriate MIME type for the web response 120. Specifically, page builder 113 inspects the file extension at the end of the URI and, if found, maps its value to the corresponding MIME type in the web server's 120 configuration.

If a MIME type for the web request 101 could not be determined by the above process, it is set to the Web Server's 120 default MIME type, as specified in the configuration.

9.3: Choose an XSL Stylesheet for Transformation.

Page builder 113 determines which XSL stylesheet should be used to transform the document 3 into a page 5. The web server's 120 configuration contains a stylesheet map for the document 3 being transformed by page builder 113 and the stylesheet map has one map entry for each XSL stylesheet that could be used to transform the document 3 into a page 5.

Each map entry contains the following fields:

url: The URL of the XSL stylesheet to which this map entry refers.

user-agent: The user-agent toward which the XSL stylesheet is targeted, if any.

mime-type: The MIME type of the page 105 that this XSL stylesheet creates.

group-id: The user community toward which the XSL stylesheet is targeted, if any.

language, country, variant: The locale toward which this XSL stylesheet is targeted.

referrer: The HTTP referrer toward which this XSL stylesheet is targeted, if any.

To determine which stylesheet 4 should be used to transform the document 3 into a page 5, each map entry in the stylesheet map is compared to attributes of the web request 101 and session. Each map entry receives a score, denoting the extent to which its target attributes match those of the web request 101 and session. The map entry with the highest score among all map entries in this stylesheet map is selected and the stylesheet it refers to is used to transform the document 3 into a page 5.

Page builder 113 enforces several constraints on the stylesheet selection process. Primarily, the chosen stylesheet must match the web request 101 on the following attributes: mime-type and language. These are referred to as mandatory attributes. If the highest scoring stylesheet does not match on all such attributes, an error is returned to request handler 110 and processing terminates abnormally. HTTP status code 500 is returned to the client.

Other attributes are optional attributes. A match on any of these attributes increases the affinity between a given stylesheet and the current web request/session. The desirability of a match between a given optional attribute and the web request/session is represented by a difference in scoring for different match types, as denoted in Table 1 below.

TABLE 1

| | Map Entry | Attribute | Score for |
|---|---|---|---|
| Web Request or Session Attribute | Attribute | Type | Match |
| User-Agent (HTTP header of Web | user-agent | optional | 13 points |
| Request) | | | |
| Mime-Type (determined in step 9.2 | mime-type | mandatory | 12 points |
| above) | | | |
| groupId (set by application in User's | group-id | optional | 5 points |
| Session) | | | |
| language (from HTTP Accept- | language | mandatory | 7 points |
| Language header of Web Request) | | | |
| Country (from HTTP Accept- | country | optional | 3 points |
| Language header of Web Request) | | | |
| variant (from HTTP Accept- | variant | optional | 2 points |
| Language header of Web Request) | | | |
| Referrer (from HTTP HTTP-Referer | referrer | optional | 1 point |
| header of Web Request) | | | |

The output page 5 must be readable by the user and the user's client software. Therefore, the chosen XSL stylesheet's map entry must score at least 19 points (mime-type and language matches) or an error occurs.

9.4: Check Page Cache

Page builder 113 then checks the page cache 105 to determine if the document 3 has previously been transformed using the chosen stylesheet 4 for the same locale, referrer and user group. If such a page 5 is found it is returned and processing terminates.

Once a stylesheet 4 has been identified, it is passed to the XSLT adapter 107, along with the original web request parameters, session and document 3.

### Step 10: Prepare for XSLT Transformation

10.1: Compile XSL Stylesheet, if Necessary

The XSLT adapter 107 checks the stylesheet cache for a precompiled version of the specified stylesheet. If none exists, the XSL stylesheet is loaded from its URL and compiled into a binary representation of it.

10.2: Pass Parameters to the XSLT Engine

The XSLT adapter 107 then initiates the XSLT engine component, and passes the following parameters to it:

1. The language, country, and variant that should be used when transforming the document 3 (as XSL parameters);

2. The document 3 to be transformed;

3. All parameters found in the web request 101, and all of the attributes found in the session (as XSL parameters).

10.3: Request Document Transformation

The XSLT adapter 107 then invokes the XSLT engine's transformation process.

### Step 11: Transform Document using XSLT

The XSLT engine, which is a third party software application, transforms the document 3 into a stream of output bytes that will become the payload of the output page 5. This is done using the standard extensible stylesheet language for transformations (XSLT) process, as specified by the World Wide Web Consortium (W3C).

### Step 12: Validate XSLT Output

The XSLT adapter 107 receives the page payload back from the XSLT engine and wraps it in a new in-memory XML document 3, with the XSLT output contained within a “payload” XML node. This new XML document 3 is returned to page builder 113.

### Step 13: Create and Cache Page

13.1: Create a Page

Page builder 113 adds one XML processing instruction to the XML document 103 returned from the XSLT adapter 107:

content-type—The MIME type of the web response that will wrap the new page 5.

13.2: Cache the Page

The output page 5 has now been created, and is added to the page cache 105 by page builder 113.

### Step 14: Create Web Response

14.1: Set Web Response Content

Request handler 110 creates a Web Response 106 and sets its content to the page's data payload.

14.2: Set MIME Type

Request handler 110 also sets the web response's 106 MIM type to the value of the page's content-type processing instruction.

14.3 Set Session Cookie

If this is the first web response 106 sent to the user in this web session, request handler 110 now sets an HTTP cookie containing the unique identifier of the user's session object, so that it may be recalled during subsequent web requests 101. The term web session as used herein refers to one or more interaction between the web server 120 and the user over a short period of time. A web session begins when the first URL is requested from the web server 120 and ends when the user leaves the application for another web site, closes their web browser, or does not request another URL for a significant period of time.

### Step 15: Transmit Web Response and Terminate

Request handler 110 transmits the web response 106 back to the user and closes the network connection.

Variations, modifications and changes to the present invention will make themselves apparent to one skilled in the art in view of the above. All such variations and modifications of the present invention are intended to fall within the spirit and scope of the present structure limited solely by the appended claims.

1. A method for managing web server presentations comprised of the steps of:
a) analyzing attributes associated with a web request from a user;
b) formatting a document to be sent to the user based upon the attributes;
c) transmitting data corresponding to the document to the user.

2. The method of claim 1 further comprised of the step of forming a set of commands based on the attributes.

3. The method of claim 2 further comprised of the step of executing the commands to format the document.

4. The method of claim 3 wherein the step of formatting the document comprises the step of obtaining data and information from external systems.

5. The method of claim 4 wherein the formatting is performed by a translator that translates the document into a page having a standardized format.

6. The method of claim 5 wherein the translator has a stylesheet for storing formats corresponding to particular attributes.

7. The method of claim 1 further comprised of the additional step of preemptively caching web instances.

8. The method of claim 7 further comprised of the additional step wherein the web instances are selected from the group consisting of commands, documents and pages.

9. The method of claim 7 wherein the preemptive caching is multilayered.

10. The method of claim 1 wherein the attributes are selected from the list consisting of URI, the identifier of a stylesheet map and the identifier of a map entry.

11. The web management system of claim 1 sending session data to one or more other web servers using session replication protocol.

12. The web management system of claim 11 wherein the web server receives copies of the session data from other server instances.

13. The web management system of claim 12 wherein ownership of the specific session instances is transferred.

14. A method for managing web server presentations comprising the steps of:
a) receiving a web request;
b) executing one or more commands in response to the web request within the server to obtain resulting data;
c) converting the resulting data from the one or more commands into a standardized representation in the form of a document;
d) examining the document for attributes and selecting a stylesheet based on the attributes, said stylesheet having transformation rules;
e) transforming the document into a page by applying the transformation rules found in the stylesheet;
f) delivering the page to a user in the form of a web response.

15. The method of claim 14 wherein the stylesheet is selected from a stylesheet cache.

16. The method of claim 14 wherein the page is selected from a page cache.
